(19) United States
(12) Patent Application Publication
(10) Pub. No.: US 2007/0068036 A1
(43) Pub. Date: Mar. 29, 2007

(54) Laundry cleaning appliance and control method thereof

(76) Inventor: Kang Mo Choi, Masan-si (KR)

Correspondence Address: FLESHNER & KIM, LLP, P.O. BOX 221200, CHANTILLY, VA, 20153, US

(21) Appl. No.: 11/509,798

(22) Filed: Aug. 25, 2006

(30) Foreign Application Priority Data
Aug. 27, 2005 (KR) 10-2005-0079139

(51) Int. Cl. F26B 21/06; F26B 13/10; F26B 19/00

(52) U.S. Cl. 34/528; 34/550; 34/73

(57) ABSTRACT

A laundry cleaning appliance according to the present invention includes a drum, a heater, a blower, a dryness sensor and a controller. The drum accommodates fabrics. The heater and the blower supply hot air to the drum. The dryness sensor detects the dryness of fabrics. The controller controls the temperature of the heater depending on changes in the dryness of fabrics detected by the dryness sensor. The temperature of hot air is controlled so as to be high by the heater when the dryness of fabrics is low, so that there are advantages in that the performance of drying for fabrics is improved, and the drying time of fabrics is shorten. The temperature of hot air is controlled so as to be low by the heater when the dryness of fabrics is high, so that there are advantages in that the over-dry of fabrics is prevented and, thus damages due to the over-dry of fabrics is prevented.

This application claims the benefit of Korean Patent Application No. 10-2005-0079139 filed on Aug. 27, 2005, which is hereby incorporated by reference for all purposes as if fully set forth herein.

### BACKGROUND OF THE INVENTION

1. Field of the Invention

The present invention relates, in general, to a laundry cleaning appliance and the control method thereof, and more particularly, to a laundry cleaning appliance which controls the temperature of a heater according to the dryness of fabrics in multi stages and the control method thereof.

2. Description of the Conventional Art

In general, laundry cleaning appliances are apparatuses for washing or drying clothes, bedclothes, etc. (hereinafter, referred to as “fabrics”) by rotating the drum with them being contained in the drum. According to functions, the laundry cleaning appliances may be classified into a washing machine that removes pollutants stained on fabrics by employing water, a detergent, a mechanical action, and so on, a dryer having only a drying function of drying wet fabrics, and a washing machine combined with a dryer having both a washing function and a drying function.

The dryer and the washing machine combined with a dryer includes a drum for accommodating fabrics, a blower and a heater for supplying hot air to the inside of the drum.

Furthermore, the dryer and the washing machine combined with a dryer can be classified into a condenser type and a vented type depending on a method of processing air (hereinafter referred to as moist air) evaporating moisture from fabrics. The condenser type removes moisture by condensing moisture of the moist air into water for condensation (hereinafter referred to as cooling water) and then heats the air the moist of which is removed using a heater and circulates and supplies it into the inside of the drum. The vented type vents the moist air exhausts to the outside.

The above-described conventional the dryer and the washing machine combined with a dryer dry fabrics using hot air having a fixed temperature by controlling a heater so as to have a fixed temperature from the beginning of drying to the end thereof, and, when the dryness of the fabrics reaches a target dryness, turns off the heater, thereby terminating the drying.

However, in the conventional laundry cleaning appliance, the temperature of hot air is maintained to be constant regardless of the dryness of fabrics. Therefore, there are problems in that the temperature is sufficiently not high when the dryness of fabrics is low, so that the drying time for fabrics becomes longer, and the temperature of hot air is relatively too high when the dryness of fabrics is high, so that the over-dry of fabrics may occur.

Furthermore, there are problems in which, when, as described above, the drying time of fabrics become longer, the time for which the heater is turned on increases, thereby increasing power consumption, and, when the over-dry of fabrics occurs, the fabrics may be damaged, thereby decreasing the reliability of the laundry cleaning appliance.

### SUMMARY OF THE INVENTION

Accordingly, the present invention has been made in view of the above problems, and it is an object of the present invention to provide a laundry cleaning appliance which improves drying performance by controlling hot air so as to have an appropriate temperature in multi stages according to changes in the dryness of fabrics and the control method thereof.

Another object of the present invention is to provide a laundry cleaning appliance in which the drying time of fabrics is shorten and the over-dry of fabrics is prevented.

To achieve the above objects, a laundry cleaning appliance according to the present invention a drum for accommodating fabrics; a heater and a blower for supplying hot air to the drum; a dryness sensor and for detecting dryness of fabrics; and a controller for controlling temperature of the heater depending on changes in the dryness of fabrics detected by the dryness sensor.

The laundry cleaning appliance further includes a heater-temperature sensor for detecting temperature of the hot air heated by the heater.

The laundry cleaning appliance further includes a condensing duct for condensing moisture of air having dried the fabrics.

The dryness sensor includes an upper portion-temperature sensor for measuring an upper-portion temperature of the condensing duct and a lower portion-temperature sensor for measuring a lower-portion temperature of the condensing duct.

The laundry cleaning appliance is a washing machine combined with a condensing type dryer.

The laundry cleaning appliance is a vented type dryer.

A method of controlling a laundry cleaning appliance according to the present invention includes the step of controlling a heater such that a temperature of hot air supplied to fabrics differs depending on a dryness of fabrics.

The method of controlling a laundry cleaning appliance controls the heater to have a high temperature when the dryness of fabrics is low, controls the heater to have a low temperature when the dryness of fabrics is high.

The method of controlling a laundry cleaning appliance divides the dryness of fabrics into a plurality of stages.

The method of controlling a laundry cleaning appliance controls the heater to have different temperatures for the respective stages.

The method of controlling a laundry cleaning appliance determines dryness based on a difference between an upper-portion temperature of a condensing duct and a lower-portion temperature of the condensing duct.

The method of controlling a laundry cleaning appliance includes a first sub-step of supplying hot air, temperature of which falls within a first set temperature range which is higher than the reference temperature range to the fabrics; a second sub-step of supplying hot air, temperature of which falls within a second set temperature range which is lower than the first set temperature range to the fabrics after the first sub-step; and a third sub-step of supplying hot air, temperature of which falls within a third set temperature range which is lower than the second set temperature range to the fabrics after the second sub-step.

The first sub-step is performed when a difference between an upper-portion temperature of a condensing duct and a lower-portion temperature of the condensing duct falls within a first dryness range.

The second sub-step is performed when the difference between the upper-portion temperature of the condensing duct and the lower-portion temperature of the condensing duct falls within a second dryness range which is higher than the first dryness range.

The third sub-step is performed when the difference between the upper-portion temperature of the condensing duct and the lower-portion temperature of the condensing duct falls within a third dryness range which is higher than the second dryness range.

The method drives a blower when the laundry cleaning appliance dries fabrics.

The method further includes a third step of turning off the heater such that cool air is supplied to the fabrics when the dryness of fabrics reaches a target dryness.

The third step is performed for a cool-drying set time.

According to the above-described laundry cleaning appliance and the control method thereof, hot air which dries fabrics upon drying is controlled so as to have an appropriate temperature by a heater depending on the change of the dryness of fabrics, so that there is an advantages in that the drying operation of the laundry cleaning appliance is optimized and, thus the performance of drying for fabrics is improved.

Furthermore, the temperature of hot air is controlled so as to be high by the heater when the dryness of fabrics is low, so that there are advantages in that the performance of drying for fabrics is improved, the drying time of fabrics is shorten, and power consumption is reduced. The temperature of hot air is controlled so as to be low by the heater when the dryness of fabrics is high, so that there are advantages in that the over-dry of fabrics is prevented and, thus damages due to the over-dry of fabrics is prevented.

Furthermore, after the dryness of fabrics has been divided into a plurality of stages, the temperature of hot air is controlled by the heater for each stage of the dryness, so that there are advantages in that the temperature of hot air is easily controlled according to the dryness of fabrics and application to the laundry cleaning appliance is easy.

### BRIEF DESCRIPTION OF THE DRAWINGS

Further objects and advantages of the invention can be more fully understood from the following detailed description taken in conjunction with the accompanying drawings in which:

FIG. 1 is a cross-sectional view of a laundry cleaning appliance to an embodiment of the present invention;

FIG. 2 is a flowchart illustrating a method of controlling the laundry cleaning appliance according to an embodiment of the present invention;

FIG. 3 is a graph showing temperature changes upon a drying operation by the laundry cleaning appliance according to an embodiment of the present invention.

FIG. 4 is a cross-sectional view of a laundry cleaning appliance to another embodiment of the present invention

FIG. 5 is an exploded perspective view of the principal portions of the laundry cleaning appliance according to another embodiment of the present invention; and

FIG. 6 is a flowchart illustrating a method of controlling the laundry cleaning appliance according to another embodiment of the present invention.

### DETAILED DESCRIPTION OF THE PREFERRED EMBODIMENT

The present invention will now be described in detail in connection with specific embodiments with reference to the accompanying drawings.

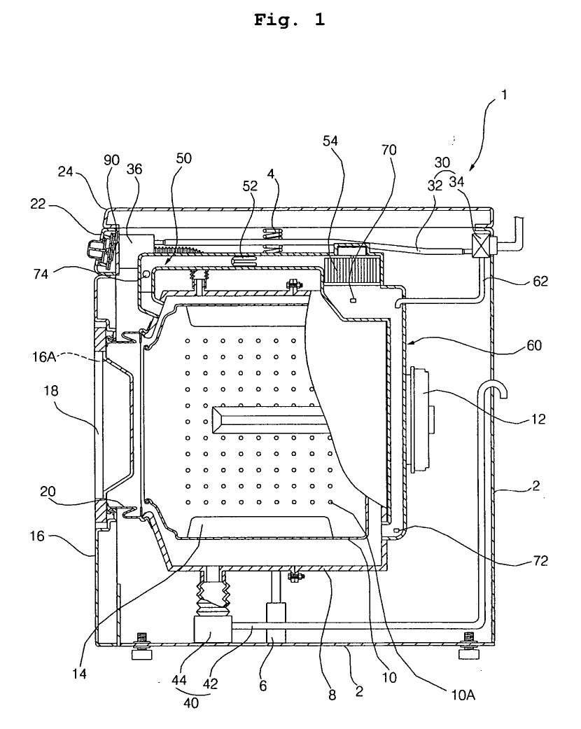

FIG. 1 is a perspective view of a laundry cleaning appliance to an embodiment of the present invention.

The laundry cleaning appliance 1 to the embodiment of the present invention, which is a washing machine combined with a dryer having both a washing function and a drying function, includes, as illustrated in FIG. 1, a cabinet 2 forming the outer appearance of the washing machine combined with a dryer 1, a tub 8 mounted inside the cabinet 2, a drum 10 rotatably disposed within the tub 8 and having a plurality of through-holes 10A, a driving motor 12 mounted in the rear of the tub 8 to rotate the drum 10, and a lifter 14 mounted on the inner surface of the drum 10 to lift fabrics to a certain height and drop them as the drums is rotated.

The cabinet 2 is mounted on the upper portion of a base 3.

A cabinet cover 16 in which a fabric inlet/outlet opening 16A is formed is mounted on the front side of the cabinet 2.

A door 18 for opening and closing the fabric inlet/outlet opening 16A is rotatably mounted in the cabinet cover 16.

A gasket 20 which relieves shocks due to the rotation of the drum 10 and, at the same time, seals off between the door 18 and the tub 8 is disposed between the cabinet cover 16 and the tub 8.

A control panel 22 in which a display unit for displaying the operation state of the a washing machine combined with a dryer 1 is provided and a manipulation unit for manipulating the operation of the washing machine combined with a dryer 1 is mounted as well in the upper portion of the cabinet cover 16.

A top plate 24 is mounted on the upper side of the cabinet 2.

A water-supplying apparatus 30 which is composed of a water-supplying hose 32 and a water-supplying valve 34 for supplying water into the inside of the tub 8 is disposed between the top plate 24 and the tub 8.

a detergent-supplying apparatus 36 is formed in the water-supplying passage of the water-supplying apparatus 30 to be communicated therewith in order to allow detergent to be supplied into the inside of the tub 8 along with water.

The tub 8 is connected to the cabinet 2 via an elastic member 4 and to the base 3 via a damper 6 as well in order to be shock-proof disposed in the inside of the cabinet 2.

A drain apparatus 40 which is composed of a drain hose 42 and a drain pump 44 for exhausting washing water used for washing, rinsing or the like, water resulting from the spin-drying of fabrics, and cooling water used for drying to the outside is mounted in the lower portion of the tub 8.

A drying apparatus which dries fabric provided to the inside of the drum 10 using dry and hot air and, at the same time, removes moisture of moist air in a condensing manner is mounted in the upper portion and rear of the tub 8.

The drying apparatus includes a dry duct 50 for discharging dry and hot air into the inside of the tub 8 and a condensing duct connected to the dry duct 50 and the tub 8.

A heater 52 for heating air inflowing from the condensing duct 60 to a high temperature is mounted the inside of the dry duct 50.

The blower 54 enables air within the drum 10 to sequentially pass through the tub 8, the condensing duct 60, and the dry duct 50 and then to be circulated to the inside of the drum 10 is mounted in the dry duct 50.

The dry duct 50 is longitudinally disposed on the upper portion of the tub 8 in a front-rear direction, and the front portion thereof is mounted the frond side of the tub 8 to be communicated therewith in order to allow hot air to be supplied to the inside of the drum 10.

The condensing duct 60 is longitudinally disposed on the side portion or rear portion of the tub 8 in an up-down direction, the upper portion of which is connected to the rear of the dry duct 50 to be communicated therewith, and the lower portion of which is connected to the lower portion of the rear surface of the tub 8 to be communicated therewith.

A cooling water-supplying apparatus 62 which supplies cooling water for condensing the moisture of moist air inflowing from the tub 8 into the inside of the condensing duct 60 is mounted on the condensing duct 60.

The washing machine 1 combined with a dryer further includes a dryness sensor for detecting the dryness of fabrics dried by the drying apparatus.

The dryness sensor includes a upper portion-temperature sensor 70 which is mounted on the upper portion of the inside of the condensing duct 60 and detects the temperature of air from which the moisture is evaporated by cooling water, and a lower portion-temperature sensor 72 which is mounted on the lower portion of the inside of the condensing duct 60 and detects the temperature of cooling water evaporating moisture from the moist air.

The washing machine 1 combined with a dryer further includes a heater-temperature sensor 74 which is mounted in the front portion of the inside of the dry duct 60 and detects the temperature of air heated by the heater 5, that is, hot air.

The washing machine 1 combined with a dryer further includes a controller 90 which controls the driving motor 12 in response to the manipulation of the control panel 22, determines dryness using the detected values of dryness sensors 70 and 72 upon drying and controls the temperature of heater 52 in multi stages according to the determined dryness.

The controller 90 is mounted in the control panel 90.

Meanwhile, a hole sensor or the like for detecting the amount of fabrics accommodated within the drum is mounted in the drying motor 12.

The operation of the washing machine combined with a dryer according to the embodiment of the present invention, construed as describe above, is described below.

First, when a user puts fabrics into the inside of the drum 102, closes a door 18 and then provides a detergent to a detergent-supplying apparatus 36.

Thereafter, when the user manipulates the control pad 22, the washing machine combined with a dryer 1 detects the amount of the fabrics which is putted to the drum 10 and sets a drying course, a washing time, the number of rinsing and the like.

The following description is given under the assumption that the user inputs information all about washing, rinsing, spin-drying, and drying.

In the washing machine 1 combined with a dryer, the water-supplying valve 31 of the water-supplying apparatus 30 supplies water, and the supplied water is mixed with a detergent while passing through the detergent-supplying apparatus 28 and is supplied to the tub 8.

Furthermore, the driving motor 12 reverses the drum 10 in a left-right direction for washing.

When the drum 10 is reversed in a left-right direction, fabrics within the drum 10 are lifted to a certain height by drum 10 and the lifter 14 and then dropped due to gravity, so that pollutants stained on fabrics is removed by the dropping of the fabrics and the washing by the detergent.

When the fabrics is washed for the set washing time, the driving of the driving motor is interrupted and the drain pump 44 of the drain apparatus 40 pumps washing water within the tub 8 to the drain hose 42 and exhausts it to the outside of the washing machine 1 combined with a dryer.

When the above-described washing operation is terminated, the driving motor 12 rotates the drum 10 at a high speed, so that the moisture of the fabrics within the drum 10 is centrifugally removed.

The water centrifugally removed from the fabrics is drawn to the tub 8 through the through holes of the drum 10. The drain pump 44 of the drain apparatus 40 pumps it to the drain hose 42, thereby exhausting it to the outside of the washing machine 1 combined with a dryer.

Thereafter, in the washing machine 1 combined with a dryer, the water-supplying valve 32 of the water-supplying apparatus 30 supplies water and the supplied water passes through the detergent-supplying apparatus 28 and is then supplied to the tub 8.

Furthermore, the driving motor 12 reverses the drum in a left-right direction for washing.

When the drum 10 is reversed in a left-right direction, fabrics within the drum 10 are lifted to a certain height by drum 10 and the lifter 14 and then dropped due to gravity, so that the detergent on fabrics is removed by the dropping of the fabrics and the washing by the detergent.

When the fabrics is washed for the set rinsing time, the driving of the driving motor is interrupted and the drain pump 44 of the drain apparatus 40 pumps water used for rinsing to the drain hose 42, thereby exhausting it to the outside of the washing machine 1 combined with a dryer.

When the above-described rinsing operation is terminated, the driving motor 12 rotates the drum 10 at a high speed, so that the moisture of the fabrics within the drum 10 is centrifugally removed.

The water centrifugally removed from the fabrics is drawn to the tub 8 through the through holes of the drum 10. The drain pump 44 of the drain apparatus 40 pumps it to the drain hose 42, thereby exhausting it to the outside of the washing machine 1 combined with a dryer.

Thereafter, the washing machine 1 combined with a dryer performs a drying operation.

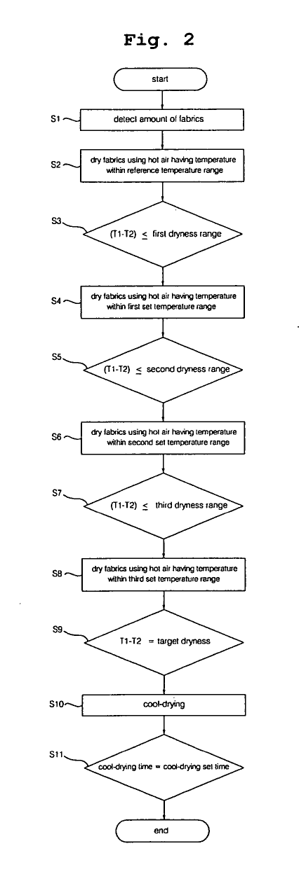

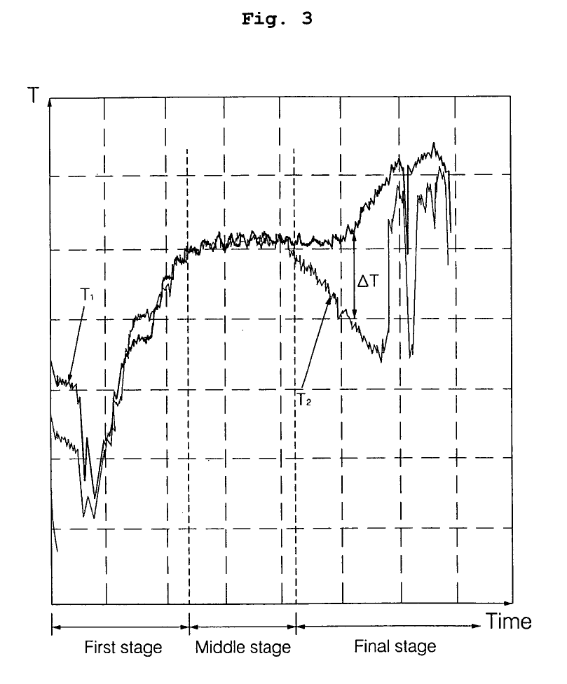

FIG. 2 is a flowchart illustrating a method of controlling the laundry cleaning appliance according to an embodiment of the present invention, and FIG. 3 is a graph showing temperature changes upon a drying operation by the laundry cleaning appliance according to an embodiment of the present invention.

The method of controlling the washing machine combined with a dryer according to the embodiment of the present invention is described in detail below with reference to FIGS. 2 and 3.

First, a controller 90 performs the detection of the amount of fabrics for detecting the amount of fabrics at step S1.

In this case, the detection of the amount of fabrics may be performed by detecting a time taken to rotate the drum 10 one time through the driving of the driving motor 12 and then calculating the amount of fabrics in proportion to the detected time, or may be performed by any one of conventional methods of detecting the amount of fabrics.

The controller 90 sets a drying course, a drying time, a target dryness and the like according to the detected amount of fabrics.

Thereafter, the controller 90 drives the driving motor 12, turns on the heater 52, drives a blower 54 and operates a cooling water supplier 62.

When the driving motor 12 is driven, the drum 12 is rotated, and the fabrics within the drum 10 are tumbled.

Furthermore, when the heater 52 is turned on, the blower 54 is driven and the cooling water supplier 62 is operated, air contained within the drying duct 50 is heated by the heater 52 and is then transformed into hot air. The hot air is supplied to the drum 10, is transformed into wet air while drying fabrics and is introduced into the condensing duct 60 after passed through the through-holes of the drum 10 and between the drum 10 and the tub 8 in turn.

The wet air which has been introduced into the condensing duct 60 passes through the condensing duct 60, so that moisture is condensed into cooling water which is supplied to the condensing duct 60. Thereafter, the air is circulated to the drying duct 50. Such air circulation continues, hereby continuously drying fabrics.

Meanwhile, in the washing machine combined with a dryer 1 during the above-described drying operation, a upper portion-temperature sensor 70 detects a upper portion-temperature T1 within the condensing duct 60 and then outputs it to the controller 90, and a lower portion-temperature sensor 72 detects a lower portion-temperature T2 within the condensing duct 60 and then outputs it to the controller 90. A heater-temperature sensor 74 detects the temperature of air heated by the heater 52 and outputs it to the controller 90.

The controller 90 controls the heater 52 so as to supply hot air having a temperature within a reference temperature range to fabrics at step S2.

That is, the controller 90 controls the turning on/off of the heater 52 such that the temperature value detected by the heater-temperature sensor 74 falls within the reference temperature range.

For example, when the reference temperature range is set to 97° C. to 100° C., the controller 90 turns on the heater 52 until the temperature value detected by the heater-temperature sensor 74 reaches the upper limit 100° C. of the reference temperature range, and, when the temperature value detected by the heater-temperature sensor 74 reaches 100° C., turns off the heater 52. When the temperature value detected by the heater-temperature sensor 74 reaches the lower limit 97° C. of the reference temperature range, the controller 90 again turns on the heater 52, and, thereafter, repeatedly turns on/off the heater 52 such that the temperature of hot air falls within the range of 97° C. to 100° C.

During the above-described control of the heater 52, fabrics are dried, and the upper portion-temperature T1 within the condensing duct 60 and the lower portion-temperature T2 within the condensing duct 60, as illustrated in FIG. 3, increases while converging to a value similar to the value upon the beginning of the drying operation and is maintained in a constant temperature range at a value mostly similar to the value upon the middle of the drying operation.

Furthermore, in the washing machine combined with a dryer 1, as illustrated in FIG. 3, upon the end of the drying operation, the detected temperature value T1 (hereinafter referred to as the upper portion-temperature of the condensing duct) of the upper portion-temperature sensor 70 increases, and, in contrast, the detected temperature value T2 (hereinafter referred to as the lower portion-temperature of the condensing duct) of the lower portion-temperature sensor 72 decreases, so that the difference Δ T between the upper portion-temperature T1 of the condensing duct and the lower portion-temperature T2 of the condensing duct gradually increases.

That is, when the drying of fabrics comes to the finish, the difference Δ T between the upper portion-temperature T1 of the condensing duct and the lower portion-temperature T2 of the condensing duct becomes larger as time elapsed, the dryness of fabrics can be measured from the difference Δ T.

The controller 90 controls the heaters in multi stages such that the temperature of hot air differs according to the dryness of fabrics.

In this case, the controller controls the heater 52 so as to have a high temperature when the dryness of fabrics is low, thereby making the drying faster, and controls the heater 52 so as to have a low temperature in order to preventing the over-dry of fabrics when the dryness of fabrics is high.

Furthermore, the controller 90 divides the dryness of fabrics into a plurality of stages, controls the heater 52 to have different temperatures according to the plurality of stages, and, when the dryness of fabrics reaches a target dryness, turns off the heater 52.

For convenience of description, the following description is given under the assumption that the dryness of fabrics is divided into three stages and the heater 52 is controlled in three stages according to the dryness.

The controller controls the heater 52 so as to supply hot air having a temperature a first set temperature range which is higher than the reference temperature range to fabrics when the magnitude of the difference Δ T between the upper portion-temperature T1 of the condensing duct and the lower portion-temperature T2 of the condensing duct falls within a first dryness range at steps S3 and S4.

For example, when the reference temperature range is set to 97° C. to 100° C., the first set temperature range is set to 102° C. to 105° C., and a first dryness range is set to 0° C. to 3° C., the controller 90 turns on the heater 52 until the temperature value detected by the heater-temperature sensor 74 reaches the upper limit 105° C. of the first set temperature range (102° C. to 105° C.), and turns off the heater 52 when the temperature value detected by the heater-temperature sensor 74 reaches 105° C. When the temperature value detected by the heater-temperature sensor 74 reaches the lower limit 102° C. of the first set temperature range (102° C. to 105° C.), the controller 90 again turns on the heater 52, and, thereafter, repeatedly turns on/off the heater 52 such that the temperature of hot air falls within the range of 102° C. to 105° C.

That is, since the washing machine combined with a dryer 1 is controlled such that the heater 52 supplies hot air which falls within the first set temperature range which is higher than the reference temperature range, hot air higher than hot air having a temperature the reference temperature range is supplied to the inside of the drum 10, thereby more rapidly drying fabrics than the case of continuously supplying hot air having a temperature the reference temperature range.

During the control of the heater 52, the difference Δ T between the upper portion-temperature T1 of the condensing duct and the lower portion-temperature T2 rapidly increases, and, as time elapsed, becomes higher than the upper limit of the first dryness range.

Meanwhile, the controller 90 controls the heater 52 so as to supply hot air having a temperature a second set temperature range which is lower than the first set temperature range to fabrics when the difference Δ T between the upper portion-temperature T1 of the condensing duct and the lower portion-temperature T2 of the condensing duct falls within the second dryness range which is higher than the first dryness range through the above-described control at steps S5 and S6.

In this case, the second set temperature range may be set to be higher or lower than the reference temperature range, and may be set to be identical to the reference temperature range. The following description is given under the assumption that the second set temperature range is set to be identical to the reference temperature range in order to preventing a drying time from being longer.

For example, when the first set temperature range is set to 102° C. to 105° C., the second set temperature range is set to 97° C. to 100° C., and a second dryness range is set to 4° C. to 8° C., the controller 90 turns off the heater 52 until the temperature value detected by the heater-temperature sensor 74 reaches the lower limit 97° C. of the second set temperature range (97° C. to 100° C.), and turns on the heater 52 when the temperature value detected by the heater-temperature sensor 74 reaches 97° C. When the temperature value detected by the heater-temperature sensor 74 reaches the upper limit 100° C. of the second set temperature range (97° C. to 100° C.), the controller 90 again turns off the heater 52, and, thereafter, repeatedly turns on/off the heater 52 such that the temperature of hot air falls within the range of 97° C. to 100° C.

That is, since the washing machine combined with a dryer 1 is controlled such that the heater 52 supplies hot air, the temperature of which falls within the second set temperature range, that is, the reference temperature range, which is lower than the first set temperature range, the over-dry of fabrics which may occur in the case of continuously supplying hot air having a temperature the first set temperature range to fabrics can be prevented, thereby drying the fabrics sufficiently and continuously.

During the control of the heater 52, the difference Δ T between the upper portion-temperature T1 of the condensing duct and the lower portion-temperature T2 more increases, and, as time elapsed, becomes higher than the upper limit of the second dryness range.

Meanwhile, the controller 90 controls the heater 52 so as to supply hot air having a temperature a third set temperature range which is lower than the second set temperature range to fabrics when the difference Δ T between the upper portion-temperature T1 of the condensing duct and the lower portion-temperature T2 of the condensing duct falls within the third dryness range which is higher than the second dryness range through the above-described control at steps S7 and S8.

For example, when the second set temperature range is set to 97° C. to 100° C., the third set temperature range is set to 87° C. to 90° C., and a third dryness range is set to 9° C. to 10° C., the controller 90 turns off the heater 52 until the temperature value detected by the heater-temperature sensor 74 reaches the lower limit 87° C. of the third set temperature range (87° C. to 90° C.), and turns on the heater 52 when the temperature value detected by the heater-temperature sensor 74 reaches 87° C. When the temperature value detected by the heater-temperature sensor 74 reaches the upper limit 90° C. of the third set temperature range (87° C. to 90° C.), the controller 90 again turns off the heater 52, and, thereafter, repeatedly turns on/off the heater 52 such that the temperature of hot air falls within the range of 87° C. to 90° C.

That is, since the washing machine combined with a dryer 1 is controlled such that the heater 52 supplies hot air, the temperature of which falls within the third set temperature range, which is lower than the second set temperature range, the over-dry of fabrics which may occur in the case of continuously supplying hot air, the temperature of which falls within the second set temperature range to fabrics can be prevented, and the time taken for cool-drying can be minimized or the temperature of fabrics can be lowered as possible.

During the control of the heater 52, the difference Δ T between the upper portion-temperature T1 of the condensing duct and the lower portion-temperature T2 more increases, and, as time elapsed, reaches the upper limit of the third dryness range.

Meanwhile, the controller 90 turns off the heater 52 when the difference Δ T between the upper portion-temperature T1 of the condensing duct and the lower portion-temperature T2 reaches the target dryness at steps S9 and S10.

In this case, the target dryness may be set to be higher than the upper limit of the third dryness range, and may be set to the upper limit of the third dryness range. The following description is given under the assumption that the target dryness is set to the upper limit of the third dryness range.

The controller 90 turns off the heater 52, and continues to drive the driving 12 and the blower 54 in order to perform cool-drying.

In this case, the cool-drying is performed in order to preventing burns due to the high temperature of fabrics when a user takes out dried fabrics from the washing machine combined with a dryer 1, and the driving 12 and the blower 54 is driven for a cool-drying set time (for example six minutes) while the heater 52 is turned off.

During the above-described cool-drying, cool air, the temperature of which is relatively cooler than the hot air upon the turning on of the heater 52 is supplied to fabrics, and, then the temperature of fabrics rapidly decreases.

The controller 90 stops the driving of the driving 12 and the blower 54 when the cool-drying set time is lapsed after the heater 52 has been turned off, and then the drying process is terminated at step S11.

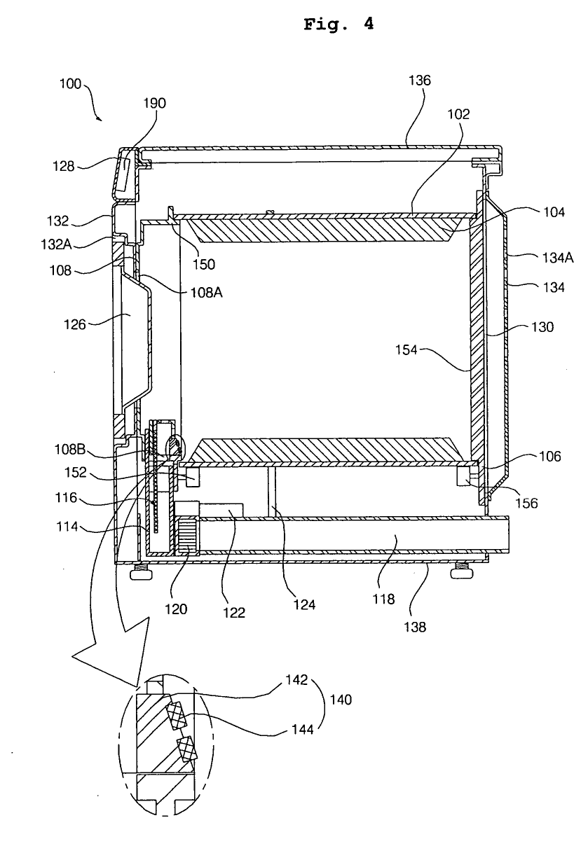

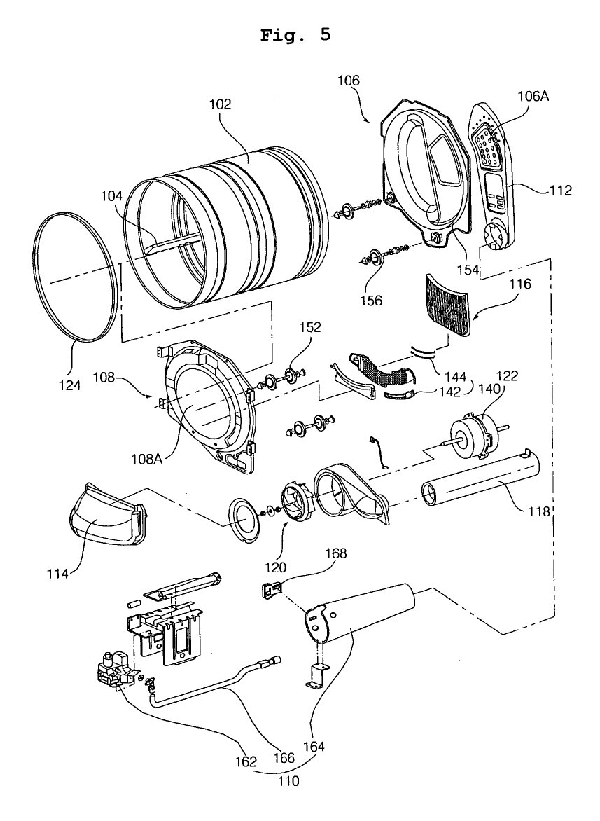

FIG. 4 is a cross-sectional view of a laundry cleaning appliance to another embodiment of the present invention and FIG. 5 is an exploded perspective view of the principal portions of the laundry cleaning appliance according to another embodiment of the present invention.

The laundry cleaning appliance 1 to this embodiment of the present invention, which is a vented type dryer having only a drying function, includes, as illustrated in FIGS. 4 and 5, a casing 2 forming the outer appearance thereof, a drum 102 mounted in the inside of the casing and having the front portion and rear portion which are opened, a lifter 104 mounted on the inner surface of the drum 102 to lift fabrics to a certain height and releases the fabrics by dropping them, a rear supporter 106 mounted on the rear surface of the casing so as to obdurate and rotatably support the rear portion of the drum 102, a front supporter 108 mounted on the front surface of the casing so as to obdurate and rotatably support the front portion of the drum 102, and a heater 110 mounted in the lower portion of the drum 102 for heating air inflowing from the outside.

A air-supplying duct 112 is mounted between the rear supporter 106 and the drying heater 110 to be communicated therewith such that air heated by the heater 110 is supplied to the inside of the drum 102.

A lint duct 114 into which air having passed through the drum 102 flows is mounted in the front supporter 108.

A filter assembly 116 for filtering out the foreign substance of the inflowing air is mounted in the lint duct 114.

An exhaust duct 118 through the rear surface of the casing is mounted in the casing such that air having passed through the lint duct 114 is guided to the outside of the casing.

A blower 120 which enables air outside the casing to pass through the inside of the casing, the heater 110, the air-supplying duct 112, the drum 102, the lint duct 114 and the exhaust duct 118 in turn and to be exhausted to the outside of the casing is mounted between the exhaust duct 118 and the lint duct 114.

A driving motor 122 for generating the driving power of the blower 120 and the drum 102 and a gear belt 124 for rotating the drum 102 in conjunction with the driving motor 122.

The casing includes a cabinet 130, a cabinet cover 132 mounted in the front surface of the cabinet 130, on the middle portion of which a fabric inlet/outlet opening 132A and on the rear surface of which the front supporter 108, a back panel 134 mounted on the rear surface of the cabinet 130, in which air-inflowing holes 134A are formed, the top plate 136 mounted to cover the upper surface of the cabinet 130, and the base 130 mounted in the lower surface of the cabinet 130.

A door 126 for opening/closing the fabric inlet/outlet opening 132A is rotatably mounted in the front surface of the cabinet cover 132. The control panel 128 for displaying the operational state of the vented type dryer 100 and controls the operation of the vented type dryer 100 is mounted in the front surface of the cabinet cover 132.

A hole portion 108A is mounted in the center of the front supporter 108 so as to be communicated with the fabric inlet/outlet opening 132A and a insert hole 108B into which the filter assembly is inserted is formed in the lower portion of the hole portion 108A to be communicated with the lint duct 114.

A guide projection which contacts the internal surface of the front portion of the drum 102 thereby guiding the rotation of the drums is formed in the rear surface of the front supporter 108, and a front guide roller 152 for rotatably supporting the front portion of the drum which is lifted is mounted in the lower portion of the rear surface of the front supporter 108.

A disk-shaped guide portion 154 which contacts the internal surface of the rear portion of the drum 102, thereby guiding the rotation of the drum 1 is protruded to be single stepped from the front surface of the rear supporter 106. A air-exhaust opening 106A to which one side of the air-supplying duct 112 is connected to be communicated therewith and which exhausts heated air is formed in the upper portion of the front surface. A rear guide roller 156 for rotatably supporting the front portion of the drum which is lifted.

Meanwhile, the dryer further includes a dryness sensor 140 for detecting the dryness of the fabrics accommodated in the drum 102.

The dryness sensor 140 is most preferably mounted in the filter assembly 116.

The dryness sensor 140 includes a sensor housing 142 mounted in and fixed to the rear surface of the filter assembly 116 and made out of non-conductive material and a electrode sensor 144 mounted in the sensor housing 142 and made out of conductive material.

In this case, the sensor housing 142 is an injection molding made out of plastic material, the surface opposite to the inside of the drum 102 is formed to be inclined downward at a predetermined gradient and easily contacts fabrics tumbled by the rotation of the drum.

Furthermore, the electrode sensor 144 is a pair of electrodes made out of metal material having excellent conductivity and is mounted apart from the inclined surface of the sensor housing 142 by a predetermined distance. The positive and negative electrodes are respectively connected to the pair of electrode.

When the fabrics within the drum 102 contacts the pair of electrodes, the pair of electrodes is conducted by the fabrics, and the magnitude of voltage detected between the pair of electrodes differs depending on the amount of moisture content contained in the fabrics.

That is, when the moisture content of the fabrics increases, potential difference between the pair of electrodes decreases, and, when the moisture content of the fabrics decreases, potential difference between the pair of electrodes increases.

As a result, the vented type dryer 100 measures the moisture content of fabrics from the potential difference detected by the dryness sensor 140, so that the dryness of the fabrics is precisely determined upon the drying of fabrics.

Generally, upon the beginning of drying, a large amount of moisture is contained in the fabrics, and the dryness of fabrics is very low, so that the voltage V detected by the electrode sensor 144 of the dryness sensor 140 is detected at a very small magnitude.

In contrast, upon the middle of drying, a moderate amount of moisture is contained in the fabrics, and the dryness of fabrics is little higher than the dryness of the fabrics upon the beginning of drying, so that the voltage V detected by the electrode sensor 144 of the dryness sensor 140 is detected at a magnitude which is higher than the voltage upon the beginning of drying.

Upon the end of drying, a little amount of moisture is contained in the fabrics, and the dryness of fabrics is little higher than the dryness of the fabrics upon the middle of drying, so that the voltage V detected by the electrode sensor 144 of the dryness sensor 140 is detected at a magnitude which is higher than the voltage upon the middle of drying.

Meanwhile, the heater 110 includes a burner 162 for generating hot air by heating air through the oxidation of gas, a fennel 164 communicating with the air-supplying duct 112 and conically hollowed, and a gas pipe 166 for connecting an external gas source and the burner 162.

The funnel 160 has an rear portion having a small cross-sectional area which is connected to the another end of the air-supplying duct 112 to be communicated therewith, and a front portion having a large cross-sectional area, into which part of the burner 162 is inserted.

A heater-temperature sensor 164 for detecting the temperature of air heated by the heater 110 is mounted in the one end of the funnel 160.

The heater 110 increases or decreases the temperature of hot air by adjusting the amount of gas through a gas adjuster (not shown) installed in the gas pipe 166.

The dryer further includes a controller 190 mounted in the control panel 128 for controlling the heater 110 and the driving motor 122 in response to the manipulation of the control panel 128.

The controller not only determines dryness using the detected value of the dryness sensor 140 but controls the temperature of hot air generated from the heater depending on the dryness in multi stages.

The operation of the laundry cleaning appliance according to another embodiment of the present invention is described below.

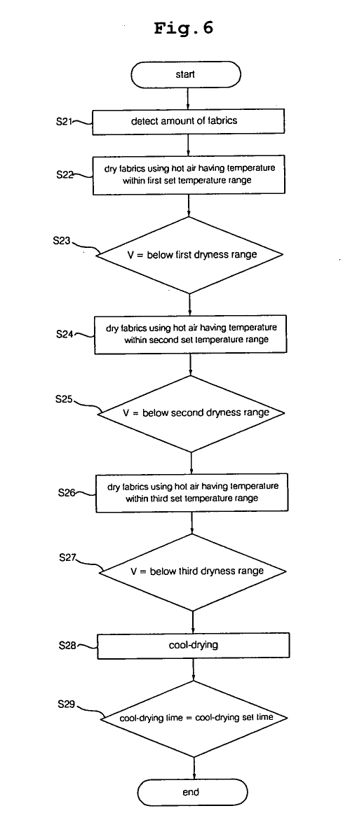

FIG. 6 is a flowchart illustrating a method of controlling the laundry cleaning appliance according to another embodiment of the present invention.

First, when a user puts fabrics into the inside of the drum 102, closes a door 126 and then manipulates a control pad 128, the controller 190 detects the amount of the fabrics which is putted to the drum 102 and sets a drying time, a target dryness and the like at step S21.

Thereafter, the controller 190 drives the driving motor 122 and, at the same time controls the heater 110.

During the driving of the driving motor 122, the drum 102 is rotated by a gear belt 124, and the blower 120 is driven.

Upon the rotation of the drum 102, the fabrics within the drum 102 are tumbled by the drum 102 and the lifter 104. At this time, the fabrics intermittently contact with the electrode sensor 144 of the dryness sensor 140 and the dryness sensor 140 measures the dryness of the fabrics.

When the blower 102 is driven, air surrounding the dryer is induced into the air-inlet hole 134A of the back panel 134 and then inflows into the heater 110. Thereafter, the air is heated by passing through the heater 110 and then inflows into the inside of the drum 102 through the air-supplying duct 112.

The hot air inflowing into the drum 102 evaporates moisture from the fabrics by passing through the drum 102, thereby drying the fabrics. Thereafter, the hot air passes through the lint duct 114 and the exhaust duct 118 in turn and is then exhausted through the exhaust duct 118.

In the dryer, the temperature of hot air supplied to the fabrics is controlled depending on the temperature of the heater 110, and the controller 190 controls the temperature of heater 110 in multi states depending on the dryness of fabrics.

The multi-stage control of the temperature of the heater according to the dryness of fabrics is described in detail below.

First, the controller 190 controls the heater 110 so as to supply hot air, the temperature of which falls within a first set temperature range while the dryness of fabrics measured by the dryness sensor 140 falls within a first dryness range at steps S22 and S23.

In this case, the first dryness range is the dryness at the beginning of drying, and set to be lower than a second dryness range and a third dryness range to be described below.

Furthermore, the first set temperature range is the temperature of hot air at the beginning of drying, and set to be higher than a second set temperature range and a third set temperature range to be described below.

As described above, when the drying of fabrics is performed using the hot air, the temperature of which falls within the first set temperature range, the dryer more rapidly dries the fabrics than the case in which the fabrics are dried by hot air the temperature of which falls within the second set temperature range, or hot air the temperature of which falls within the third set temperature range. As time is lapsed, voltage V detected by the electrode sensor 144 of the dryness sensor 140 gradually increases.

The controller 190 terminates the control for the first set temperature range of the heater 110 when the voltage V detected by the dryness sensor 140 exceeds the first dryness range.

Next, the controller 190 controls the heater 110 to supply hot air the temperature of which falls within the second set temperature range while the dryness of the fabrics measured by the dryness sensor 140 falls within the second dryness range at steps S24 and S25.

In this case, the second dryness range is set to be higher than the first dryness range and is set to be lower than the below-described third dryness range.

Furthermore, the second set temperature range is set to be lower than the first set temperature range and is set to be higher than the below-described third set temperature range.

As described above, when fabrics is dried by hot air, the temperature of which falls within the second set temperature range, the over-dry of fabrics which may occur in the case in which the dryer continuously supplies hot air the temperature of which falls within the first set temperature range to fabrics can be prevented, and the fabrics is more rapidly dried than the case in which hot air the temperature of which falls within the below-described third set temperature.

The controller 190 terminates the control of the second set temperature of the heater 110 when the voltage V detected by the dryness sensor 140 exceeds the second dryness range.

Thereafter, the controller 190 controls the heater 110 so as to supply hot air the temperature of which falls within the third set temperature range while the dryness of fabrics measured by the dryness sensor 140 falls within the second dryness range at steps S26 and S27.

As described above, when fabrics is dried by hot air, the temperature of which falls within the third set temperature range, the over-dry of fabrics which may occur in the case in which the dryer continuously supplies hot air the temperature of which falls within the second set temperature range to fabrics can be prevented, and the time taken for cool-drying can be minimized, or the temperature of fabrics upon the cool-drying can be lowered as possible.

The controller 190 terminates the control of the third set temperature of the heater 110 when the voltage V detected by the dryness sensor 140 exceeds the third dryness range.

Furthermore, the controller 190 turns off the heater 110 at step S28.

The controller 190 turns off the heater 110, but continues to drive the driving motor 112 in order to perform the cool-drying.

In this case, the cool-drying is performed in order to preventing burns due to the high temperature of fabrics when a user takes out dried fabrics from the dryer, and the driving 112 is only driven for a cool-drying set time (for example six minutes) while the heater 110 is turned off.

During the above-described cool-drying, cool air, the temperature of which is relatively cooler than the hot air upon the turning on of the heater 110 is supplied to fabrics, and, then the temperature of fabrics rapidly decreases.

The controller 90 stops the driving of the driving 12 when the cool-drying set time is lapsed after the heater 52 has been turned off, and then the operation of the dryer is terminated at step S29.

Although the laundry cleaning appliance and the control method thereof are described with reference to the illustrated drawings, the present invention is not limited to the above-described embodiments and it is apparent that drawings and various modifications can be made by the those skilled in the art without departing from the technical scope of the resent invention.

That is, the dryness of fabrics is divided into, if necessary, four or more states rather than three stages, so that the temperature of hot air upon the drying of fabrics can be more precisely controlled.

The laundry cleaning appliance and the control method thereof according to the present invention have the following advantages.

According to the above-described laundry cleaning appliance and the control method thereof, hot air which dries fabrics upon drying is controlled so as to have an appropriate temperature by a heater depending on the change of the dryness of fabrics, so that there is an advantages in that the drying operation of the laundry cleaning appliance is optimized and, thus the performance of drying for fabrics is improved.

Furthermore, the temperature of hot air is controlled so as to be high by the heater when the dryness of fabrics is low, so that there are advantages in that the performance of drying for fabrics is improved, the drying time of fabrics is shorten, and power consumption is reduced. The temperature of hot air is controlled so as to be low by the heater when the dryness of fabrics is high, so that there are advantages in that the over-dry of fabrics is prevented and, thus damages due to the over-dry of fabrics is prevented.

Furthermore, after the dryness of fabrics has been divided into a plurality of stages, the temperature of hot air is controlled by the heater for each stage of the dryness, so that there are advantages in that the temperature of hot air is easily controlled according to the dryness of fabrics and application to the laundry cleaning appliance is easy.

What is claimed is:

1. A laundry cleaning appliance, comprising:
a drum for accommodating fabrics;
a heater and a blower for supplying hot air to the drum;
a dryness sensor and for detecting dryness of fabrics; and
a controller for controlling temperature of the heater depending on changes in the dryness of fabrics detected by the dryness sensor.

2. The laundry cleaning appliance as set forth in claim 1, further comprising a heater-temperature sensor for detecting temperature of the hot air heated by the heater.

3. The laundry cleaning appliance as set forth in claim 1, further comprising a condensing duct for condensing moisture of air having dried the fabrics.

4. The laundry cleaning appliance as set forth in claim 3, wherein the dryness sensor includes an upper portion-temperature sensor for measuring an upper-portion temperature of the condensing duct and a lower portion-temperature sensor for measuring a lower-portion temperature of the condensing duct.

5. The laundry cleaning appliance as set forth in claim 1, wherein the laundry cleaning appliance is a washing machine combined with a condensing type dryer.

6. The laundry cleaning appliance as set forth in claim 1, wherein the laundry cleaning appliance is a vented type dryer.

7. A method of controlling a laundry cleaning appliance, comprising the step of controlling a heater such that a temperature of hot air supplied to fabrics differs depending on a dryness of fabrics.

8. The method as set forth in claim 7, wherein the method controls the heater to have a high temperature when the dryness of fabrics is low, controls the heater to have a low temperature when the dryness of fabrics is high.

9. The method as set forth in claim 5, wherein the method divides the dryness of fabrics into a plurality of stages.

10. The method as set forth in claim 9, wherein the method controls the heater to have different temperatures for the respective stages.

11. The method as set forth in claim 7, wherein the method determines dryness based on a difference between an upper-portion temperature of a condensing duct and a lower-portion temperature of the condensing duct.

12. The method as set forth in claim 7, further comprising:
a first step of controlling the heater so as to supply hot air, temperature of which falls within a reference temperature range, to the fabrics; and
a second step of controlling the heater so as to be different temperatures of hot air depending on the dryness of fabrics after the first step.

13. The method as set forth in claim 12, wherein the second step comprises:
a first sub-step of supplying hot air, temperature of which falls within a first set temperature range which is higher than the reference temperature range to the fabrics;
a second sub-step of supplying hot air, temperature of which falls within a second set temperature range which is lower than the first set temperature range to the fabrics after the first sub-step; and
a third sub-step of supplying hot air, temperature of which falls within a third set temperature range which is lower than the second set temperature range to the fabrics after the second sub-step.

14. The method as set forth in claim 13, wherein the second sub-step supplies hot air, temperature of which falls within a temperature range identical to the reference temperature range.

15. The method as set forth in claim 13, wherein the first sub-step is performed when a difference between an upper-portion temperature of a condensing duct and a lower-portion temperature of the condensing duct falls within a first dryness range;
the second sub-step is performed when the difference between the upper-portion temperature of the condensing duct and the lower-portion temperature of the condensing duct falls within a second dryness range which is higher than the first dryness range; and
the third sub-step is performed when the difference between the upper-portion temperature of the condensing duct and the lower-portion temperature of the condensing duct falls within a third dryness range which is higher than the second dryness range.

16. The method as set forth in claim 12, wherein the method drives a blower when the laundry cleaning appliance dries fabrics.

17. The method as set forth in claim 16, further comprising a third step of turning off the heater such that cool air is supplied to the fabrics when the dryness of fabrics reaches a target dryness.

18. The method as set forth in claim 16, wherein the third step is performed for a cool-drying set time.

19. A method of controlling a laundry cleaning appliance, comprising the steps of:
a first step of controlling a heater so as to supply hot air, temperature of which falls within a first set temperature range, to fabrics;
a second sub-step of supplying hot air, temperature of which falls within a second set temperature range which is lower than the first set temperature range to the fabrics after the first sub-step; and
a third sub-step of supplying hot air, temperature of which falls within a third set temperature range which is lower than the second set temperature range to the fabrics after the second sub-step.

20. The method as set forth in claim 19, wherein:
the first step is performed when the dryness of fabrics falls within a first dryness range;
the second step is performed when the dryness of fabrics falls within a second dryness range which is higher than the first dryness range;
the third step is performed when the dryness of fabrics falls within a third dryness range which is higher than the second dryness range; and
a cool-drying is performed by turning off the heater after the third step.
